(19) United States
(12) Patent Application Publication
(10) Pub. No.: US 2011/0265622 A1
(43) Pub. Date: Nov. 3, 2011

(54) Dough Feeding System

(76) Inventors: Thomas G. BERGER, Ridgefield, NJ (US); Moysey Shtilerman, Elmwood Park, NJ (US)

(21) Appl. No.: 13/098,736

(22) Filed: May 2, 2011

Related U.S. Application Data
(60) Provisional application No. 61/330,512, filed on May 3, 2010.

(51) Int. Cl. B26D 7/32; B26D 7/06; B26D 5/20

(52) U.S. Cl. 83/80; 83/436.75; 83/367

(57) ABSTRACT

Disclosed herein is a dough feeding system and methods corresponding thereto. In some embodiments, the dough feeding system includes a cutting subsystem, an alignment subsystem, a belt assembly, a conveyor, and/or combinations thereof. The alignment system can be provided with a movable platform for aligning a dough ribbon into the cutting subsystem. The cutting subsystem can be provided with a frame securable to the belt assembly, a drive roller for feeding dough, and a knife blade for cutting the dough. The belt assembly can include a flat-belt, and the conveyor can include a dough folding platform with rough edges. Electronic controller(s) are provided for (i) synchronizing the drive roller with the knife blade, (ii) synchronizing the drive roller with a position of the dough folding platform, and/or (iii) adjusting the movable platform to compensate for drift of the dough ribbon.

### CROSS-REFERENCE TO RELATED APPLICATIONS

The present application claims the benefit under 35 U.S.C. §119(e) of U.S. Provisional App. No. 61/330,512, filed May 3, 2010, which is hereby incorporated by reference in its entirety for all purposes.

### FIELD OF THE INVENTION

The present invention relates to apparatus and methods for feeding dough onto an assembly line. More specifically, the present invention relates to systems and methods for feeding lengths of dough cut from a dough ribbon onto an assembly line for making egg rolls or other food products.

### BACKGROUND OF THE INVENTION

It is known in the art to provide systems and methods for feeding dough onto an assembly line for making egg rolls. For example, U.S. Pat. No. 3,912,433 (the “Ma '433 Patent”) discloses an egg roll making machine that includes a dough feeding device for cutting portions of dough from a roll thereof. The egg roll making machine of the Ma '433 Patent includes a roll of dough dispensed onto a specially-configured plate by a plurality of rollers, and a knife device is provided to cut the dough in a plurality of directions to form irregularly-shaped portions of dough. What are needed in the art, however, are improved dough feeding systems and methods that provide enhanced cutting mechanisms and/or synchronized dispensing.

### SUMMARY OF THE INVENTION

The present invention overcomes the disadvantages and shortcomings of the prior art by providing a dough feeding system comprising a cutting subsystem, and, in some embodiments, an alignment subsystem. In some aspects, the cutting subsystem can provide for synchronized dispensing.

The cutting subsystem can receive a continuous ribbon of dough and cut the dough ribbon into desired lengths of dough, which can be further processed by an assembly line, such as a food processing line for making egg rolls. The cutting subsystem preferably includes a frame, a motor, a drive roller driven by the motor, a plurality of idle rollers biased against the drive roller, and a knife blade driven by a pneumatic solenoid-actuated cylinder, for example. In some aspects, the idle rollers retain the dough against the drive roller, which moves the dough through the compact frame, and the knife blade is preferably mounted to the frame parallel with the drive roller when the knife blade is idle. An electronic controller times actuation of the knife blade with rotation of the drive roller, such that the knife blade preferably cuts the dough transversely against the drive roller at a time when rotation of the roller has been momentarily stopped. The cut length of dough falls from the drive roller of the cutting subsystem onto a flat-belt. In some aspects, it is contemplated that the flat-belt will drop the cut lengths of dough onto a receiving device at an end distal the cutting subsystem for further processing.

In some embodiments of the invention, the receiving device comprises a conveyor having a plurality of folding platforms, each having articulable components. The folding platforms and conveyor therefore can be similar to those described in U.S. Pat. Nos. 5,912,035 and/or 7,487,718, for example, with each folding platform having a plurality of “movable parts” for folding dough received by the folding platform. The flat-belt can have a first velocity and the conveyor can have a second velocity about the same as the first velocity, while the cutting subsystem at the drive roller can have a (third) velocity greater than the first and second velocities. At least one proximity sensor is provided in electrical communication with the electronic controller for sensing the presence of a folding platform proximal a dough-receiving area at an end of the flat-belt. In this regard, the electronic controller can time-release a cut length of dough onto the flat-belt, which safely receives the cut length onto its flat surface, and which maintains the integrity of the cut dough while passing same to the folding platform of the conveyor.

In some aspects, the continuous ribbon of dough can be aligned with and fed into the cutting subsystem by any suitable means known in the art.

In some aspects, embodiments of the present invention can provide for an alignment subsystem to be provided alone and/or in combination with another structure. For example, an alignment subsystem of the present invention can be provided to align the dough ribbon for feeding into the cutting subsystem disclosed herein. The alignment subsystem can be provided with a movable platform, a plurality of sensors, and a second electronic controller (and/or the same controller as that described for the cutting subsystem). The continuous dough ribbon lies atop the movable platform and, during set-up, for example, an end of the dough ribbon can be manually or otherwise fed into the cutting subsystem in straight alignment therewith onto the drive roller. One of the plurality of sensors is positioned on either side of the dough ribbon at a position prior to that point at which the ribbon enters the cutting subsystem. As the cutting subsystem pulls the dough therethrough, the sensors identify whether the ribbon has drifted from a center position and by how much. The sensors are in electrical communication with the second controller, for example, and, if the ribbon moves out of alignment, the second controller sends an electrical signal to the movable platform, triggering the movable platform to move transversely to the left or right to align the ribbon.

Additional features, functions and benefits of the disclosed dough feeding system will be apparent from the detailed description which follows, particularly when read in conjunction with the accompanying figures.

### BRIEF DESCRIPTION OF THE DRAWINGS

For a more complete understanding of the present invention, reference is made to the following detailed description of exemplary embodiment(s) considered in conjunction with the accompanying drawings, in which:

FIG. 1 is a right side schematic showing a dough feeding system constructed in accordance with an exemplary embodiment of the present invention, the dough feeding system shown to include an alignment subsystem, a cutting subsystem having a knife blade assembly, and a flat-belt;

FIG. 2 is a front perspective view showing the cutting subsystem of FIG. 1 at a side into which dough enters the cutting subsystem;

FIG. 3 is a rear perspective view showing the cutting subsystem of FIGS. 1 and 2 at a side from which the dough is cut and exits the cutting subsystem;

FIG. 4 is a right side elevational view showing the cutting subsystem of FIGS. 1-4;

FIG. 5 is a top view of the knife blade assembly shown in FIGS. 1, 3, and 4;

FIG. 6 is a right side schematic showing a dough feeding system constructed in accordance with a second exemplary embodiment of the present invention, the dough feeding system being shown with at least one proximity sensor for identifying the presence of a folding platform proximal an end of the flat-belt; and

FIG. 7 is a front elevational schematic showing the alignment subsystem of FIG. 1.

### DETAILED DESCRIPTION OF THE EXEMPLARY EMBODIMENTS

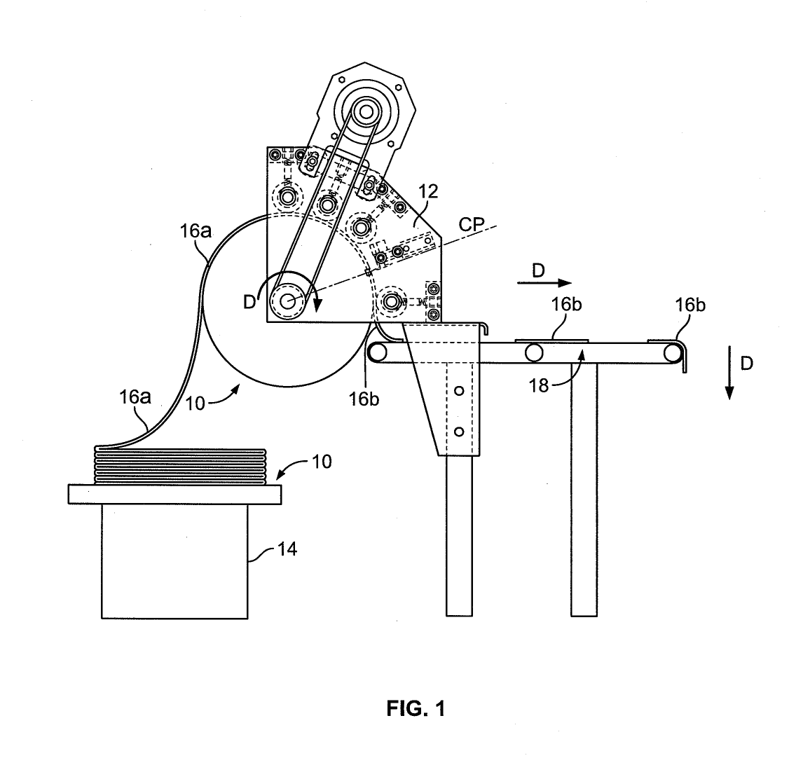

Referring to FIG. 1, a schematic shows a dough feeding system 10 constructed in accordance with an exemplary embodiment of the present invention. The dough feeding system 10 includes a cutting subsystem 12 and an alignment subsystem 14, each of which shall be further discussed below. To facilitate consideration and discussion, the dough feeding system 10 is shown in combination with a dough ribbon 16a and a plurality of dough lengths 16b cuts therefrom, and the dough feeding system 10 preferably includes a flat belt assembly having a flat-belt 18 (with a support assembly therefor) to facilitate further processing of the dough lengths 16b, such as the making therefrom of egg rolls (and/or other rolled or unrolled food product). The direction of motion of the dough 16a, 16b is designated generally in FIG. 1 by directional arrows D.

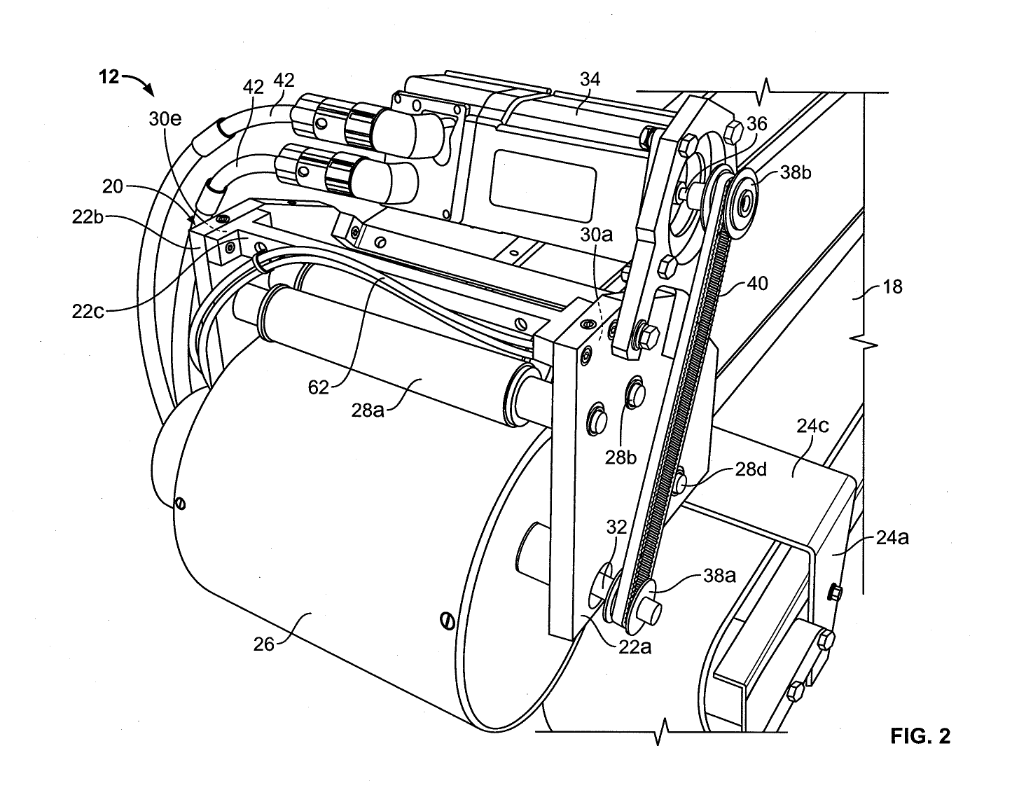

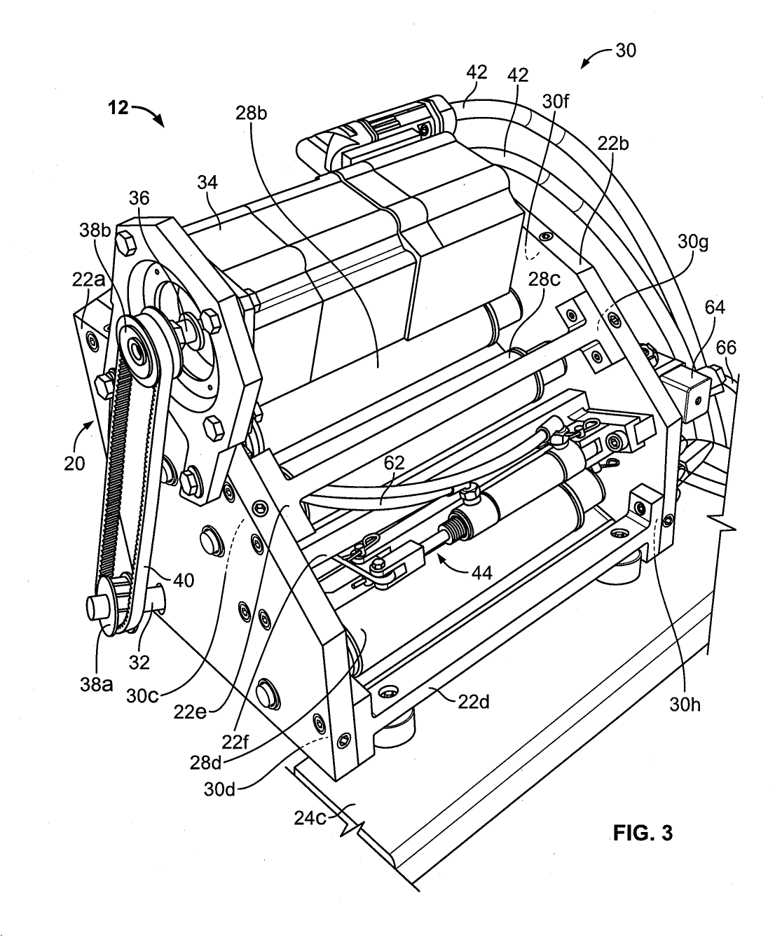

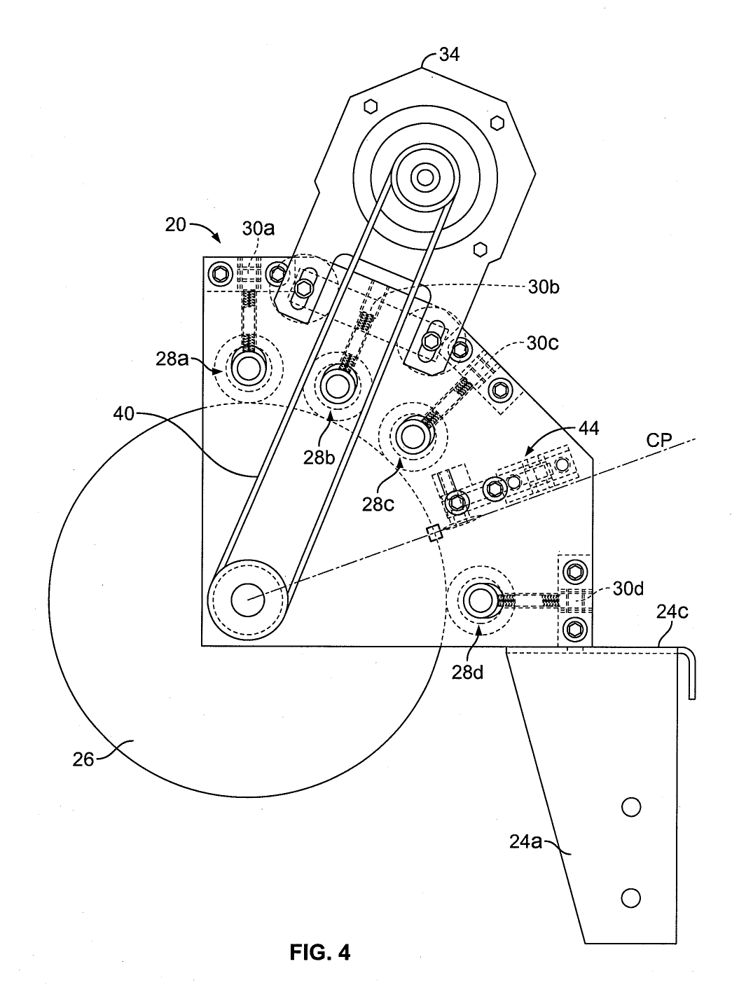

Referring to FIGS. 1-4, the cutting subsystem 12 shall now be discussed with further detail. In the exemplary embodiment shown, the cutting subsystem 12 can be characterized as a cutting device. The cutting subsystem 12 includes a compact frame 20, including a plurality of frame members, such as frame members 22a, 22b, which are spaced apart in opposition from one another so as to define an internal space therebetween. The plurality of frame members can further include additional frame members, such as frame members 22c-f, which each extend from frame member 22a to secure frame member 22b in relation thereto. Additionally, frame member 22f supports a knife blade assembly 44, which shall be discussed further below.

A plurality of mounts 24a-c are provided for releasably securing the frame 20 off to the side of the flat-belt 18 at the support assembly therefor. For example, the mount 24c can be secured to the frame members 22a, 22b, and 22d. Continuing with the example, the mounts 24a and 24b can extend downwardly from right and left sides of the mount 24c, respectively for being releasably secured off to the sides of the flat-belt 18 of the assembly line at the support assembly for the flat-belt 18. Mount 24b, which is directly “behind” mount 24a (and flat-belt 18) can be identical to mount 24a and provided as a mirror image thereof, so as to secure the frame 20 off to both sides of the flat-belt 18 at the support assembly therefor allowing dough 16b to drop from the cutting subsystem 12 onto the flat-belt 18.

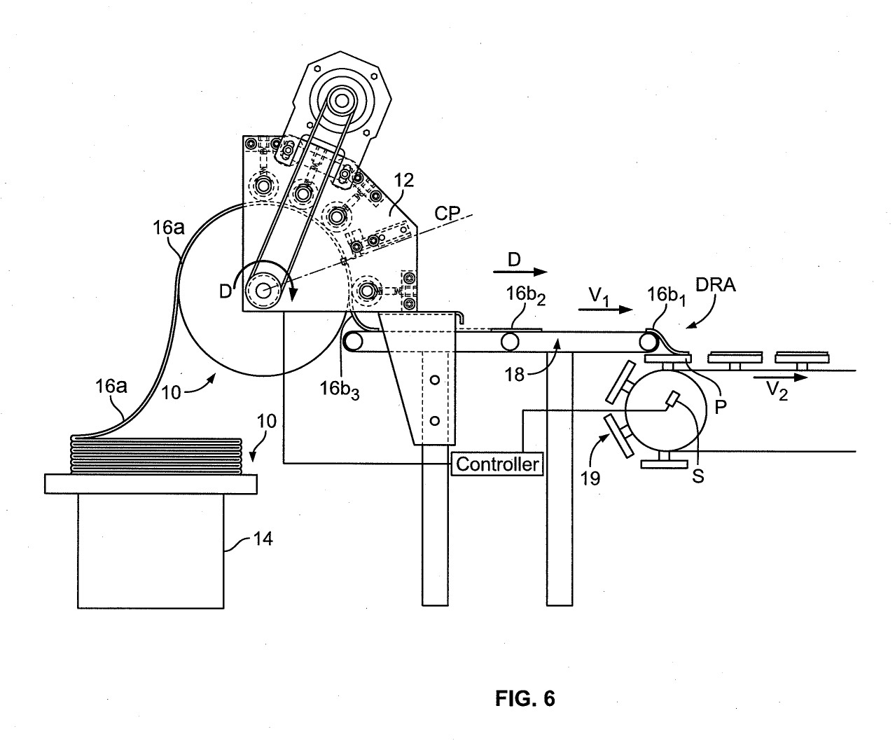

It is contemplated that, in some embodiments of the invention, a receiving device can be positioned below an end of the flat-belt 18 distal the cutting subsystem 12 for receiving a cut dough length 16b for further processing. Such receiving device can be any device. As discussed below with reference to FIG. 6, the receiving device is preferably of the folding-platform type, such as that of the eggroll folding machines of Solbern and/or those configured for eggroll processing and/or similar to the folding platforms disclosed in U.S. Pat. Nos. 5,912,035 and/or 7,487,718, the contents of both of said patents being herein incorporated by reference in their entirety.

Continuing with reference to FIGS. 1-4, the cutting subsystem 12 includes a motive element, such as a roller, which is referenced herein as a drive roller 26. The drive roller 26 extends into corresponding holes formed in the frame members 22a, 22b to allow rotation of the drive roller 26. The cutting subsystem 12 further includes a plurality of idle rollers 28a-d, which are parallel with the drive roller 26, and which are positioned about the drive roller 26 so each one of the idle rollers 28a-d is displaced radially from each adjacent one of the idle rollers 28a-d. Each one of the idle rollers 28a-d extends into corresponding holes formed in the frame members 22a, 22b to allow for rotation of the idle rollers 28a-d. Springs assemblies 30a-h or other suitable means are provided for biasing the idle rollers 28a-d against the dough and the drive roller 26. In some embodiments, the biasing force, e.g., spring tension, of the spring assemblies 30a-h can be selected, such that the idle rollers 28a-d flatten or extrude anomalies in the dough to enhance consistent dough thickness. The dough ribbon 16a is fed between the idle roller 28a and the drive roller 26, such that, when the drive roller 26 is engaged, the idle rollers 28a-c assist in motion of the dough ribbon 16a and such that the idle roller 28d assists in motion of the dough lengths 16b. The idle rollers 28a-d preferably apply sufficient pressure on the dough to inhibit or preclude slippage of the dough 16a, 16b in relation to the drive roller 26. In this regard, a cut length of dough 16b can be suspended by the idle roller 28d and the drive roller 26, with an end of said length contacting the flat-belt for a smooth release onto the flat-belt that preserves the integrity of said cut-length during transfer to the flat-belt 18. By minimizing slippage, for example, consistency is maintained between the cut size of each individual portion of dough 16b, such consistency preferably being about one sixteenth of an inch, for example.

It is contemplated that the idle rollers 28a-d can be provided as motive elements with or without an independent driving force, though such is not required.

The drive roller 26 is provided with a shaft, which is referenced herein as a roller shaft 32, and which extends through the frame member 22a and out of a side thereof distal the frame member 22b. A servomotor 34 is mounted to the frame 20 and provided with a drive shaft 36. The servomotor 34 can be positioned atop the frame members 22a, 22b with additional frame members provided for structural reinforcement, vibration reduction, etc. The roller shaft 32 and the drive shaft 36 are provided with first and second pulleys 38a, 38b, respectively, along a common plane, and a timing belt 40 engages the pulleys 38a, 38b. In this regard, operation of the servomotor 34 drives the drive roller 26. Although a servomotor 34 is preferable, it is understood that additional and/or alternative driving means can be provided, such as a step motor, for example.

The servomotor 34 and/or other drive means is provided with electrical communication lines 42 for communications between the servomotor 34 and a first electronic controller (not shown in FIG. 1). The first electronic controller provides the logic for controlling the servo motor 34, and hence the drive roller 26, and is discussed below with further detail.

A knife blade assembly 44 includes a cutting element, such as a knife blade 58, and is provided for cutting the dough ribbon 16a into dough lengths 16b. As shown, the knife blade assembly 44 is secured to the frame 20, extends parallel with the drive roller 26, and is positioned about the drive roller 26 between the idle roller 28c and the idle roller 28d. In this regard, the dough ribbon 16a engages the idle rollers 26a-c and is cut by the knife blade assembly 44 into dough lengths 16b, which engage the idle roller 26d. The knife blade assembly 44 is preferably positioned along a cutting plane CP, which extends radially from the central longitudinal axis of the drive roller 26, and, along the cutting plane CP, the knife blade 58 cuts the dough ribbon 16a transversely against the curved surface of the drive roller 26.

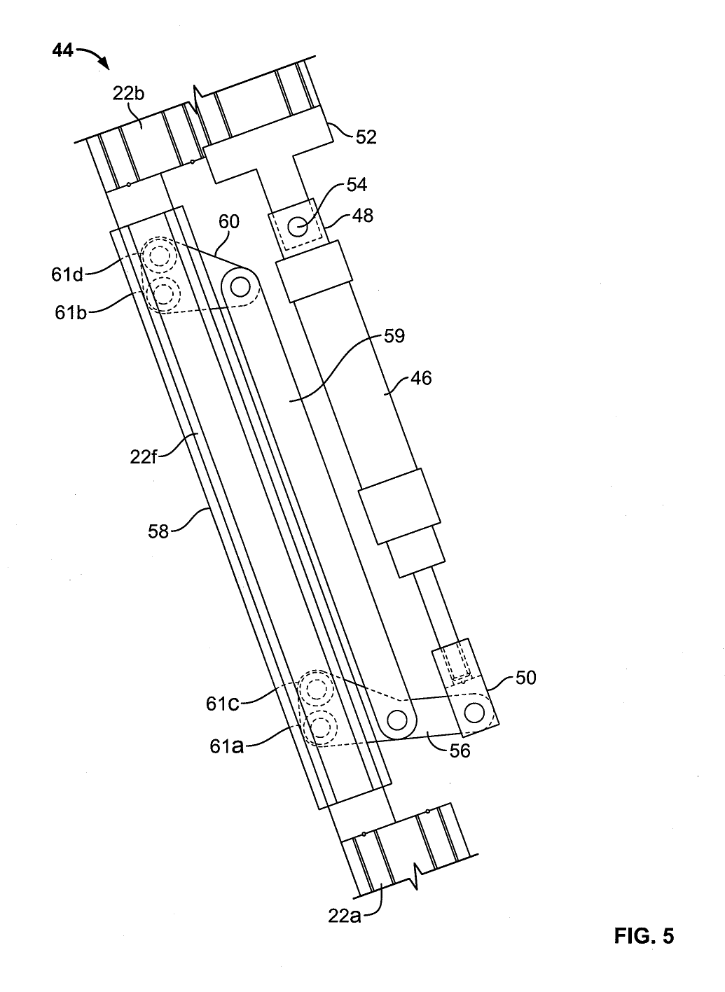

Referring to FIG. 5, the knife blade assembly 44 includes a piston 46 having a base end 48 and a movable end 50. A mount, which is referenced herein as a piston mount 52, includes a first pin 54 securing the base end 48 with respect to the frame 20, while allowing rotation of the piston 46 about the first pin 54. The movable end 50 of the piston 46 is secured by a pin to a first end of a lever 56. A second end of the lever 56 is rotatably secured to (and beneath, for example) the frame member 22f by pin 61a, and a first end of a linkage 59 is secured at a load point along the lever 56 between the first and second ends of the lever 56. A second end of the linkage 59 is secured to a first end of a connector 60, and the connector 60 has a second end rotatably secured to (and beneath, for example) the frame member 22f via pin 61b. The knife blade 58 is secured to (and beneath, for example), the lever 56 and the connector 60 via pin 61c and pin 61d respectively.

Continuing with reference to FIGS. 1-5, a fluid communication line 62 and solenoid valve 64 are provided for alternating the state of the piston 46 between a first state (extended position), in which the lever 56 has been rotated to pull the knife blade 58 along the cutting plane CP away from the drive roller 26 (inhibiting cutting), and a second state (distended position), in which the lever 56 has been rotated to pull the knife blade 58 along the cutting plane CP against the drive roller 26 (facilitating cutting). The solenoid valve 64 is mounted to the frame member 22b, and the fluid communication line 62 extends in fluid communication between the solenoid valve 64 and the piston 46. Electrical communication lines 66 secure the solenoid valve 64 to the first electronic controller, which sends the solenoid valve 64 an electrical signal controlling actuation of the piston 46, hence controlling actuation of the knife blade 58.

The first electronic controller is thus in electrical communication with both the servomotor 34 and the solenoid valve 64 for synchronous control thereof. The first electronic controller is provided with hardwired and/or software-based logic for controlling actuation of the servomotor 34 (and hence the drive roller 26) and actuation of the solenoid valve 64 (and hence the knife blade 58). In preferred embodiments, the first electronic controller is programmable with at least two states including a first state and a second state. In the first state of the electronic controller, the servomotor 34 is engaged to drive rotation of the drive roller 26 (hence moving the dough ribbon 16a) and the solenoid valve 64 is disengaged to pressurize the piston 46 to extend the movable end 50 of the piston 46 (hence distancing the knife blade 58 from the drive roller 26). In the second state of the electronic controller, the servomotor 34 is disengaged to cease rotation of the drive roller 26 (hence ceasing motion of the dough ribbon 16a) and the solenoid valve 64 is actuated to pressure the piston 46 to distend the movable end 50 of the piston 46 (hence forcing the knife blade 58 against the still drive roller 26 to cut a dough length 16b from the dough ribbon 16a).

It is contemplated that the first electronic controller can be configured to alternate between the first and second states thereof at predetermined and/or user-specified intervals of time, for example. In this regard, a dough ribbon 16a, having been fed into the cutting subsystem 12 between the drive roller 26 and the idle roller 28a, is pulled through the cavity between the frame members 22a, 22b and cut into dough lengths 16b which fall onto the flat-belt 18 of the assembly line. The first electronic controller is preferably configured to control parameters of the servomotor 34 (and/or other means), and can control velocity of the servomotor 34 and/or other drive means at predetermined and/or user-specified velocities and times. It is contemplated that the first electronic controller can be mounted to the frame member 22b and/or another suitable element of the frame 20, for example. The cut dough 16b travels along the flat-belt 18 for further processing, such as for further processing to become egg rolls. For example, the dough 16b can be filled, rolled, and/or further cut, and fried and frozen.

Referring to FIG. 6, it is further contemplated that a sensor S can be provided to synchronize the first and second states of the electronic controller with the presence of a folding platform P of a conveyor 19 at a dough-receiving area DRA positioned just below (or otherwise proximal) an end of the flat-belt 18 distal the cutting subsystem 12. The folding platform P is preferably of a type suitable for folding egg rolls and/or similar to the folding platforms of U.S. Pat. Nos. 5,912,035 and/or 7,487,718, both incorporated by reference herein. For those folding platforms P formed of machined metal parts, for example, it is contemplated that the folding platform P may include rough edges that would present an enhanced ripping hazard to dough falling downwardly from the idle roller 28d. This is unlike the substantially uninterrupted planar surface of the flat-belt 18, which can smoothly receive the dough during downward motion thereof and cross motion of the flat-belt 18. Thus, in some embodiments of the invention, the integrity of the dough 16b₁, 16b₂, 16b₃, . . . , and 16b_{N} is enhanced by using the flat-belt 18 as an intermediary means between the cutting subsystem 12 and the conveyor 19. Moreover, the velocity V₁ of the flat-belt 18 is preferably about equal to the velocity V₂ of the conveyor 19 to facilitate smooth transition of cut dough lengths 16b when same is passed from the flat-belt 18 to a platform P of the conveyor 19. The cutting subsystem 12 can be provided with a (third) velocity at the drive roller 26 greater than that of the first velocity V₁ (and second velocity V₂) as the dough 16b₃ dispensed from the idle roller 28d to the flat-belt 18 is safely received and made planar thereby.

The at least one proximity sensor S is secured at any suitable location for targeting the dough-receiving area DRA. The sensor S is configured to sense the presence of the folding platform P at the dough-receiving area DRA, and the first electronic controller alternates between the first and second states thereof in synchronization with signals from the sensor S and in accordance with known parameters such as the spacing between the dough lengths 16b, the time between cuts, the radial or linear displacement between cuts, the velocity of the roller 26, the velocity of the flat-belt 18, the length of the flat-belt 18, the speed or frequency at which the machine platform P alternates between being present and absent at the dough-receiving area DRA, and/or other known parameters.

In preferred embodiments, the flat-belt 18 is synchronized with the conveyor 19, and, with the aid of the sensor S, the first electronic controller is directly synchronized with the conveyor 19 and hence indirectly synchronized with the flat-belt 18. When a folding platform P is sensed, the first electronic controller initiates a first state thereof in which the roller 26 is driven to advance the hanging dough length 16b₃ from the idle roller 28d towards the flat-belt 18 and advance the dough ribbon 16a across the cutting plane CP, and the flat-belt 18 advances the dough length 16b₁ to the dough-receiving area DRA at a folding platform P of the conveyor 19. After a predetermined or programmed time, for example, the first electronic controller transiently initiates a second state thereof, in which the drive roller 26 momentarily stops to allow for cutting by the knife blade 58, while holding the next cut length at the idle roller 28d, thereby spacing out the cut lengths on the flat-belt 18 in coordination with the spacing of platforms on the conveyor 19.

As stated above, the dough ribbon 16a can be aligned into the cutting subsystem 12 by any suitable means known in the art. For example, the dough ribbon can be positioned upon a surface, and an end of the dough ribbon can be inserted into the cutting subsystem manually. As another example, a suitable alignment device known in the art can be provided for automatically aligning the dough ribbon end into the cutting subsystem.

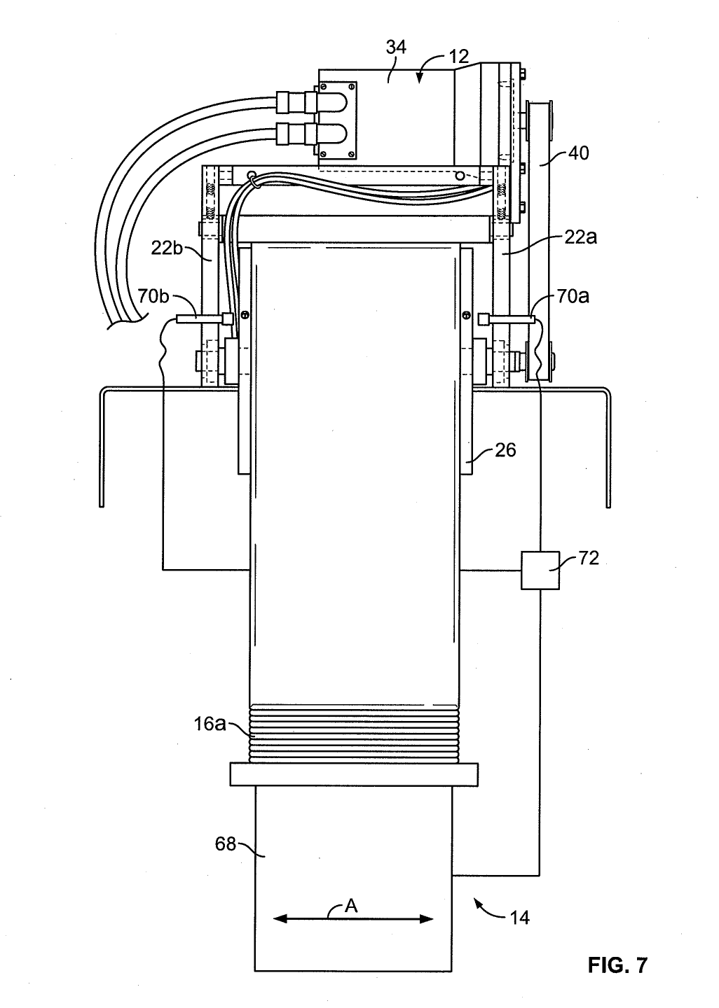

Referring to FIGS. 1 and 7, an alignment subsystem 14 of the present invention can be provided, alone and/or in combination another structure, such as the cutting subsystem 12, for example. The alignment subsystem 14 includes a movable platform 68, which includes electro-mechanical linkages known in the art for selective motion of the movable platform 68 along directional arrows A of FIG. 7. A plurality of sensors 70a and 70b are provided, which can be mounted to the frame members 22a and 22b, respectively. An electronic controller is provided for alignment, which can be the first electronic controller that controls the servomotor 34 and solenoid valve 64 and/or which can be another electronic controller 72. The sensors 70a and 70b sense the position of the dough ribbon 16a and communicate such information to the second electronic controller 72, which is provided with software and/or hardwired logic for identifying if and by how much the dough ribbon 16a has drifted from a fully-aligned position, e.g., center position, with respect to the drive roller 26. The second electronic controller 72 calculates a corresponding direction and amount to which the movable platform 68 should be adjusted transversely to the right or left along arrows A to compensate for the drift and bring the dough ribbon 16a back into alignment. In this regard, the second electronic controller 72 sends the moveable platform 68 an electric signal, and the movable platform 68 responds accordingly.

It will be understood that the embodiments of the present invention described herein are merely exemplary and that a person skilled in the art may make many variations and modifications without departing from the spirit and scope of the invention. All such variations and modifications, including those discussed above, are intended to be included within the scope of the invention as defined in the appended claims.

What is claimed is:

1. A dough feeding system, comprising:
a frame configured to mount to a belt assembly having a belt;
a knife blade assembly secured to said frame and having a knife blade; and
a drive roller supported by said frame and generally parallel with said knife blade;
wherein said knife blade and said drive roller are configured to alternate between a first state, in which rotation of said drive roller is engaged to feed dough and said knife blade is distanced from said drive roller, and a second state, in which rotation of said drive roller is ceased and said knife blade transversely cuts the dough against said drive roller to form a cut dough length.

2. The dough feeding system of claim 1, wherein said frame comprises a compact frame configured to mount to sides of the belt so as to allow the cut dough length to be dispensed onto the belt.

3. The dough feeding system of claim 1, wherein said knife blade is positioned to cut along a cutting plane extending radially from a central longitudinal axis of said drive roller.

4. The dough feeding system of claim 1, comprising a plurality of rollers biased against said drive roller for securing the dough therebetween.

5. The dough feeding system of claim 1, comprising another roller, together with said drive roller, configured to suspend the cut dough length in contact with the belt for timed-release of the cut dough length thereon.

6. The dough feeding system of claim 5, wherein said another roller is positioned downstream of a cutting plane along which said knife blade is positioned.

7. The dough feeding system of claim 1, comprising first means for driving said drive roller, second means for actuating said knife blade, and an electronic controller in communication with said first and second means for synchronous control thereof.

8. The dough feeding system of claim 1, comprising a solenoid valve for actuating said knife blade, and wherein said knife blade assembly comprises a piston responsive to said solenoid valve to move said knife blade away from said drive roller during said first state and to move said knife blade toward said drive roller during said second state.

9. The dough feeding system of claim 1, further comprising an alignment subsystem from which dough is fed to said drive roller, said alignment subsystem including a movable platform having a surface for the dough, at least one sensor for sensing a position of the dough, and an electronic controller configured to identify from the position a drift of the dough from alignment with said drive roller and to calculate an adjustment to said movable platform to compensate for the drift.

10. The dough feeding system of claim 1, further comprising the belt.

11. The dough feeding system of claim 10, further comprising a conveyor proximal an end of said belt, said conveyor comprising at least one device for receiving dough from the belt at a dough receiving area.

12. The dough feeding system of claim 11, wherein said belt has a substantially uninterrupted planar surface, and wherein said receiving device has rough edges.

13. The dough feeding system of claim 11, wherein said belt is configured to move at a first velocity, and wherein said conveyor is configured to move at a second velocity about the same as the first velocity.

14. The dough feeding system of claim 11, wherein said receiving device comprises a dough folding platform.

15. The dough feeding system of claim 14, comprising a proximity sensor for identifying the presence of said dough folding platform proximal the dough receiving area.

16. The dough feeding system of claim 15, comprising an electronic controller in communication with said proximity sensor for synchronization of said states with the presence of said dough folding platform proximal the dough receiving area so as to have said dough folding platform receive the cut dough length.

17. The dough feeding system of claim 1, further comprising the dough.

18. A dough feeding system, comprising:
a cutting subsystem configured to dispense a cut dough length, said cutting subsystem including a motive element configured to feed a dough ribbon and a cutting element configured to cut the dough length from the dough ribbon;
a flat-belt configured to operate at a first velocity and having a substantially uninterrupted surface for receiving the cut dough length from said cutting subsystem; and
a conveyor configured to operate at a second velocity about the same as the first velocity and having a dough folding platform for receiving the cut dough length from said flat-belt.

19. The dough feeding system of claim 18, wherein said dough folding platform has rough edges.

20. The dough feeding system of claim 19, wherein said dough folding platform has at least one of machined metal parts and articulable components.

21. The dough feeding system of claim 18, further comprising an alignment subsystem from which the dough ribbon is fed to said cutting subsystem, said alignment subsystem including a movable platform having a surface for the dough ribbon, at least one sensor for sensing a position of the dough ribbon, and an electronic controller configured to identify from the position a drift of the dough ribbon from alignment and to calculate an adjustment to said movable platform to compensate for the drift.

22. The dough feeding system of claim 18, wherein said cutting subsystem comprises a compact frame with which said motive element and said cutting element are secured, said compact frame being secured off to sides of said flat-belt.

23. The dough feeding system of claim 18, wherein said motive element comprises a drive roller.

24. The dough feeding system of claim 23, comprising another roller for, together with said drive roller, suspending the cut dough length in contact with said flat-belt for timed-release thereon of the cut dough length.

25. The dough feeding system of claim 24, wherein said another roller is positioned downstream of the cutting plane.

26. The dough feeding system of claim 23, wherein said cutting element is positioned to cut along a cutting plane extending radially from a central longitudinal axis of said drive roller.

27. The dough feeding system of claim 23, wherein said cutting element is positioned to cut against said drive roller.

28. The dough feeding system of claim 18, comprising an electronic controller configured for time-release of the cut dough length onto said flat-belt for passing the cut dough length to said receiving device.

29. The dough feeding system of claim 18, wherein said cutting subsystem is provided with at least one electronic controller configured to alternate between a first state, in which said motive element is engaged to dispense the cut dough length, and a second state, in which said cutting element is engaged to cut the dough ribbon.

30. The dough feeding system of claim 29, comprising a sensor in electrical communication with said at least one electronic controller for sensing the presence of said dough folding platform proximal a dough receiving area at an end of said flat-belt.

31. The dough feeding system of claim 30, wherein said at least one electronic controller is configured to synchronize said states with the presence of said dough folding platform proximal the dough receiving area so as to have said dough folding platform receive the cut dough length.

32. A dough feeding system for use with a ribbon of dough for making food products, comprising:
a cutting subsystem configured to dispense a portion cut from the dough ribbon; and
an alignment subsystem from which the dough ribbon is fed to said cutting subsystem, said alignment subsystem comprising:
a movable platform having a surface atop which the dough ribbon is positioned;
at least one sensor for sensing a position of the dough ribbon; and
an electronic controller configured to identify from the position a drift of the dough from alignment with said cutting subsystem and calculate an adjustment to said movable platform to compensate for the drift.

33. The dough feeding system of claim 32, wherein said electronic controller is configured to send a signal to said movable platform if the dough ribbon moves out of alignment to trigger said movable platform to align the dough ribbon.

34. The dough feeding system of claim 33, wherein said at least one sensor is positioned to a side of the dough ribbon prior to where the dough ribbon enters said cutting subsystem.

35. The dough feeding system of claim 32, wherein said cutting subsystem comprises a frame having frame members for mounting to sides of a belt, and wherein said at least one sensor comprises a plurality of sensors mounted to said plurality of frame members.

36. The dough feeding system of claim 32, wherein said cutting subsystem includes a drive roller and is configured to have the dough ribbon fed thereat from said alignment subsystem in straight alignment with said cutting subsystem.

37. The dough feeding system of claim 32, wherein said electronic controller calculates a corresponding direction and amount for adjustment of said movable platform.

38. The dough feeding system of claim 37, wherein said electronic controller calculates the corresponding direction to be at least one of transverse to the right and transverse to the left.

39. The dough feeding system of claim 32, wherein said electronic controller is configured to identity the drift of the dough ribbon relative to a center position thereof.
